(19) United States
(12) Patent Application Publication
(10) Pub. No.: US 2004/0223804 A1
(43) Pub. Date: Nov. 11, 2004

(54) Writing implement

(76) Inventor: Cedora Ruiz, Casper, WY (US)

Correspondence Address: WEIDE & MILLER, LTD., 7251 W. LAKE MEAD BLVD., SUITE 530, LAS VEGAS, NV, 89128, US

(21) Appl. No.: 10/762,843

(22) Filed: Jan. 21, 2004

Related U.S. Application Data
(63) Continuation of application No. 10/347,967, filed on Jan. 21, 2003, now abandoned.

(51) Int. Cl. B43K 29/00

(52) U.S. Cl. 401/195

(57) ABSTRACT

A writing implement, such as an ink pen, comprising an elongate, generally cylindrical housing. The housing defines an interior area and comprises a substantially translucent material, permitting the interior area to be viewed from the exterior of the implement. A second end of the housing and the interior are closed, such as by a cap. A tip extends from a first end of the housing. The writing implement includes at least one writing material configured to be dispensed from the tip. The writing implement includes a plurality of ornamental elements substantially filling the interior area. In one embodiment, the ornamental elements have a maximum dimension in the range of about 0.03125-0.125 inches. The ornamental elements may comprises balls. In one embodiment, the ornamental elements are colored and are arranged in the interior space to define a pattern.

### RELATED APPLICATION

This application is a continuation application of U.S. application Ser. No. 10/347,967, filed Jan. 21, 2003.

### FIELD OF THE INVENTION

The present invention relates to writing utensils or implements.

### BACKGROUND OF THE INVENTION

Writing implements are well known and have been continuously developed from ancient times forward. The improvements in writing implements have been of two primary types: novelty and operation.

With respect to operation, writing implements have evolved from simple quills dipped in ink, charcoal and similar materials to highly advanced pressurized ink-filled cartridges, mechanical lead pencils, fluorescent markers and other implements. While these advances have resulted in a great improvement in writing implements, a far greater number of variations in writing implements have been developed to make the implements more exciting and desirous to consumers. For example, ball-point pens all having the same mode of operation have been developed in thousands of different styles, colors and shapes to appeal to the consumer.

The variations in writing implement styles are widely varied. For example, U.S. Pat. No. 4,787,161 to Feng discloses a writing instrument which includes a collapsible display sheet, such as a flag. U.S. Pat. No. 5,984,556 to Gray discloses a writing instrument including a barrel with grooved outer surface which provides a unique array of light transmission. U.S. Pat. No. 6,299,372 discloses a photo pen which includes a light which illuminates a transparent surface.

### SUMMARY OF THE INVENTION

One embodiment of the invention comprises a writing implement comprising an elongate, generally cylindrical housing having a first end and a second end. The housing defines an interior area and comprises a substantially translucent material, permitting the interior area to be viewed from the exterior of the implement.

The second end of the housing and the interior are closed, such as by a cap. A tip extends from the first end of the housing.

The writing implement includes at least one writing material configured to be dispersed or dispensed from the tip. The writing implement includes a plurality of ornamental elements substantially filling the interior area between the first end and second end.

In one embodiment, the ornamental elements have a maximum dimension in the range of about 0.03125-0.125 inches. The ornamental elements may comprises balls or have a variety of shapes. In one embodiment, the ornamental elements are colored and are arranged in the interior space or area to define a pattern.

In one embodiment, the writing material comprises ink contained in a cartridge. The cartridge includes a writing tip extending from the tip of the writing implement and a well. The well comprises a generally cylindrical housing extending into the interior area of the housing. In this embodiment, the ornamental elements may be located in an annular space between the housing and the well of the cartridge.

In another embodiment, the housing comprises an inner wall and an outer wall, a first interior area defined between the inner and outer walls and a second interior area defined inside of the inner wall, the ornamental elements located in the first interior area.

In another embodiment, the interior area includes a first interior section located between the second end of the housing and a point distal of the first end, and a second interior section located between that point and the first end, the ornamental elements located in the first interior section. The first and second interior sections may be divided by a wall located in the interior space defined by the housing.

In accordance with the invention, a writing utensil includes a housing containing a plurality of ornamental elements which are viewable therethrough. The ornamental elements create a novel appearance to the writing implement which maybe customized into a variety of forms. For example, colored balls in team colors may be used to show team support. Patriotic red, white and blue balls may be utilized.

The ornamental elements obscure internal mechanism or parts of the implement, such as an ink cartridge. This makes the implement more visually appealing.

In one embodiment, the ornamental elements do not completely fill the interior area, and may be shaken to create different visual patterns as well as sound.

Further objects, features, and advantages of the present invention over the prior art will become apparent from the detailed description of the drawings which follows, when considered with the attached figures.

### DESCRIPTION OF THE DRAWINGS

FIG. 1 is a side view of a writing implement in accordance with one embodiment of the present invention;

FIG. 2is a cross-sectional view of the writing implement illustrated in FIG. 1 taken in the direction of line 2-2;

FIG. 3is a cross-sectional view of the portion of the writing implement illustrated in FIG. 1 along line 3;

FIG. 4 is a cross-sectional view of a writing implement in accordance with another embodiment of the invention;

FIG. 5 is a side view of a yet another embodiment writing implement in accordance with the invention;

FIG. 6 is an enlarged view of a portion of a writing implement in accordance with the invention illustrating one embodiment of ornamental elements located in the implement; and

FIG. 7 is an enlarged view of a portion of a writing implement in accordance with the invention illustrating another embodiment of ornamental element located in the implement.

### DETALED DESCRIPTION OF THE INVENTION

The invention is a writing implement. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In general, the invention is a writing implement containing a plurality of ornamental or decorative elements. In one embodiment, the ornamental elements fill a cavity or chamber of the writing implement, and are visible through a housing of the implement. The ornamental elements have a visually appealing appearance and have the function of obscuring internal portions of the writing implement.

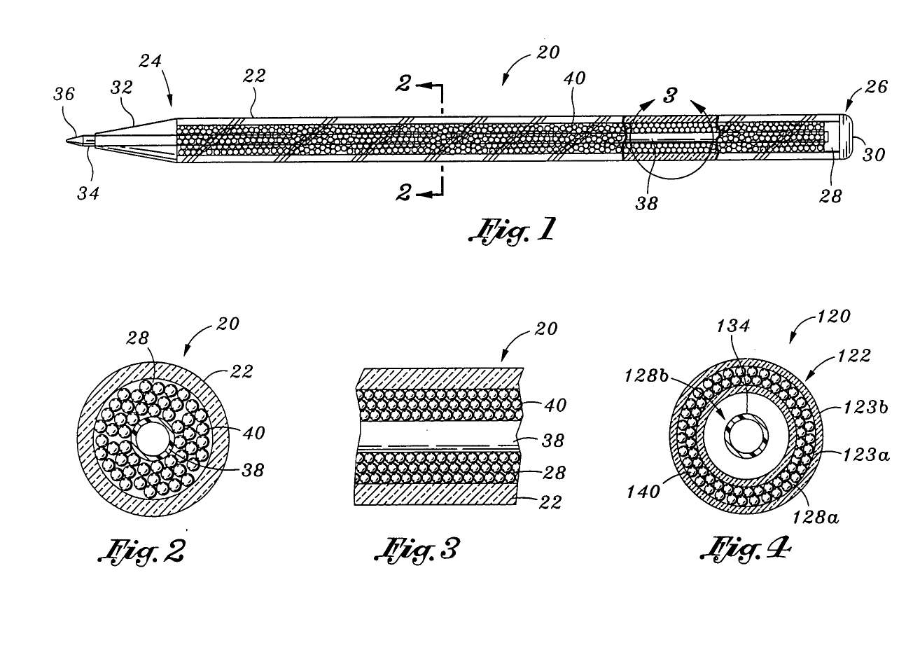

One embodiment of the invention is illustrated in FIGS. 1-3. As illustrated in FIG. 1, a writing implement 20 has a body or housing 22. The housing 22 has a first end 24 and a second end 26. As described in more detail below, the housing 22 defines an interior space 28. The interior space 28 may also be referred to as a chamber or cavity.

Preferably, the housing 22 is substantially or sufficiently transparent or translucent that a viewer may see into the interior 28 of the implement 20. The housing 22 may be constructed of a variety of materials, such as glass, plastic or the like.

The housing 22 may have a variety of sizes and shapes. In one embodiment, the housing 22 is about 0.25-0.075 inches maximum width, and about 4-8 inches long. Preferably, the housing 22 is generally cylindrical in shape, and thus comprises or is defined by a wall which is circular in cross-section, and which defines a generally cylindrical interior space 28.

Preferably, the second end 26 of the housing 22 is closed. In one embodiment, a cap 30 is located at the second end 26 of the housing 22. The cap 30 closes the second end 26 of the housing. The cap 30 may be constructed of a variety of materials. The cap 30 may be manufactured integral with the housing 22 or may connect to the housing 22 in a variety of manners, such as to be removable.

In one embodiment, a tip 32 extends from the first end 24 of the housing 22. In one embodiment, the tip 32 is a cone-shaped element which tapers in diameter from its connection to the housing 22. The tip 32 may be a separate element or the housing 22 may be formed integrally therewith, or be formed with a cartridge (described below) or other element mounted or connected to the housing 22.

In one embodiment, the implement 20 includes a cartridge 34 containing writing material is supported by the tip 32. In one embodiment, the cartridge 34 is an ink cartridge. Such cartridges are well known. As illustrated, the cartridge 34 may include a dispenser 36 and a well 38. The well 38 comprises an elongate cylinder or other housing containing ink. The ink may be of a variety of types.

The dispenser 36 of the cartridge 34 may include a roller ball or a variety of other applicators. The dispenser 36 extends outwardly beyond the tip 32 at the first end 24 of the housing 22, such as through an opening at the end of the tip 32. The well 38 extends into the interior 28 defined by the housing 22. As illustrated, in one embodiment, the well 38 extends nearly the length of the housing 22 to the second end 26.

The cap 30 and tip 32 generally enclose the ends of the housing 22, so that the interior space 28 is closed. As illustrated in FIG. 1, in accordance with the invention a plurality of ornamental or decorative elements 40 are located in the interior space 28 of the writing implement.

The ornamental or decorative elements 40 may be of a variety of types, shapes and sizes. In one embodiment, as illustrated in FIG. 1, the ornamental elements 40 comprise small spheres or balls. In one embodiment these balls have a diameter of about 0.03125 (1/32)-0.0125 (⅛) inches. Preferably, the size of the elements 40 is select so that a great number of the elements are required to fill or occupy the interior 28 of the housing 22.

Preferably, the decorative elements 40 substantially fill the interior space 28 of the writing implement 20. In the embodiment of the invention illustrated in FIGS. 2 and 3, a portion of the interior space 28 is occupied by the well 38 of the ink cartridge 34. When the ink cartridge 34 extends generally centrally through the housing 22, the otherwise unoccupied space is an annular area outside of the well 38 and inside of the housing 22. As illustrated in FIGS. 1-3, the decorative elements 40 occupy this annular space. In a preferred embodiment, the cross-section size of the well 38 is substantially less than the cross-sectional size of the interior space 28, causing the annular interior space to be of a sufficient size to permit the ornamental elements 40 to be located therein. Further, as illustrated in FIG. 2, the size of the ornamental elements 40 to the this annular space is preferably selected so that more than 2, and preferably 3 or more ornamental elements 40 may be arranged between the wall 22 and the well 38. In this manner, a “depth” of the ornamental elements (and not just a single layer) are located in the interior space 28, between the interior of the housing 22 and the internal components such as the well 38. For example, if the interior area 28 is 0.25 inches in diameter and the well 38 is 0.0625 inches in diameter, the ornamented elements may be chosen to have a size of about 0.03125 inches, so that the ornamented elements 40 will fit three deep between the housing 22 and well 38.

The ornamental elements 40 may be constructed from plastic, metal or other material. The elements 40 may be colored, and be of a single or multiple colors.

Because the housing 22 is generally transparent or translucent, the ornamental elements 40 are visible therethrough. This creates a visually appealing appearance, as the implement appears to comprise or be constructed from hundreds or thousands of individual elements.

In addition, because the decorative elements 40 occupy the space between the housing 22 and the well 38 of the cartridge 34, the well 38 is no longer visible. This is visually appealing, since it makes it appear as though the implement has no cartridge 34.

A variety of configurations of ornamental elements may be provided. In one embodiment, the elements 40 may be all the same color. In another embodiment, they may be of a variety of colors. In one embodiment, the colors of the elements 40 and their arrangement in the housing 22 may be selected to create a pattern. For example, the red, white and blue elements 40 may be grouped into sections to create a patriotic pattern. The colors may be chosen to match school colors or other configurations.

The ornamental elements 40 may be other than balls or spheres. For example, as illustrated in FIGS. 6 and 7, the ornamental elements 40 may comprise elements having a variety of other shapes. As illustrated in FIG. 6, the ornamental elements 40 may have the shape of stars. As illustrated in FIG. 7, the ornamental elements 40 may be disc-shaped. The ornamental elements 40 may have a variety of other shapes, such as other geometric shapes, the shape of animals, plants or other objects. Preferably, these ornamental elements 40 have a maximum dimension of about 0.03125-0.0125 inches. For example, the elements 40 maybe discs having a diameter of about 0.0125 inches but a depth or thickness of less than 0.03125 inches.

Ornamental elements 40 of other shapes are preferably also of a small size so that many of them (all the same, or mixed with elements having other shapes) are utilized to fill the interior space 28. The elements 40 may have a dimension less than 0.03125 inches, but a very small size may be undesirable because the elements 40 are hard to visually distinguish. The elements 40 may have a dimension larger than 0.125 inches, but preferably only if the size of the implement permits such while maintaining the criteria described above. In one embodiment, the maximum dimension of the element 40 is preferably within the stated range, though other dimensions of the element may not be, such as in the case of the disc described above.

In one embodiment, the ornamental elements 40 occupy most, but not all, of the interior space 28. In this embodiment, movement of the housing 22 “shakes” the ornamental elements 40. This movement may be used to change the orientation of the elements 40 to create ever-changing different patterns. In one embodiment, the ornamental elements 40 may be of differing sizes. The movement of the utensil will cause the elements 40 to migrate due to the differences in sizes.

In addition, the movement of the ornamental elements 40 may create a pleasing rattling or other sound.

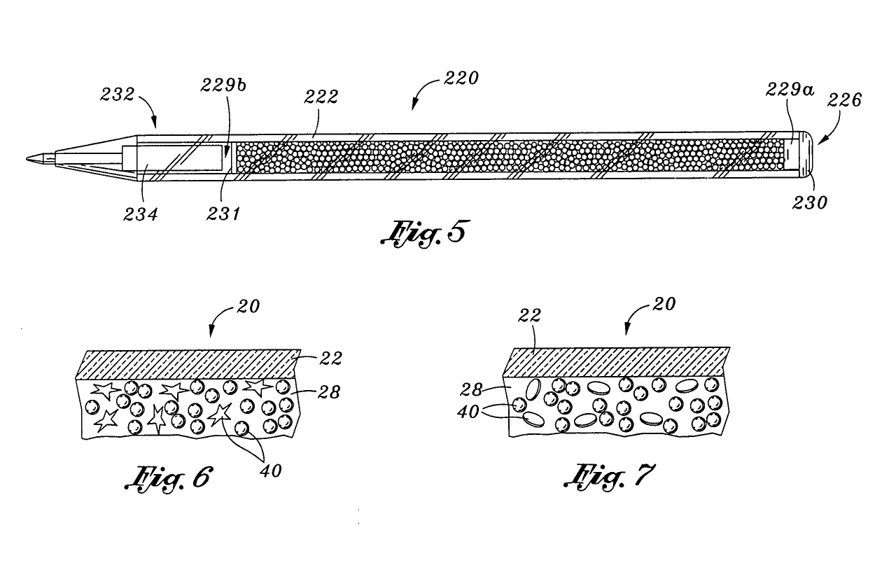

A variety of other configurations of the invention are contemplated. FIG. 4 illustrates another embodiment of the invention. As illustrated, in this embodiment, a writing implement 120 includes a housing 122 having an inner wall 123a and an outer wall 123b. A first interior space 128a is defined between the inner wall 123a and outer wall 123b. A second interior space 128b is defined inside of the inner wall 123a.

In this embodiment, the well 138 or other portion of an ink or other cartridge may extend into the second interior space 128b. Ornamental elements 140 are located in the first interior space 128a.

In this embodiment, preferably at least the outer wall 123b of the housing 122 is translucent or transparent. In that manner, the ornamental elements 140 are visible.

This embodiment writing implement 120 has generally the same advantage of the writing implement 20 described above and illustrated in FIGS. 1-3. In addition, however, this embodiment writing implement 120 has the advantage that a user may more easily remove the ink cartridge, such as by removing the tip or cap (see FIG. 1). When this occurs, the ornamental elements 140 remain undisturbed in the housing 122 since they are secured in the separate first interior space 128a.

Yet another embodiment of the invention is illustrated in FIG. 5. This embodiment implement 220 is similar to that illustrated in FIG. 1. In this embodiment, however, the interior space 228 of the housing 222 is divided into first section 229a and a second section 229b. The first section 229a extends from the second end 226 of the housing 222 at the cap 230 to a point distal (i.e. towards the second end) of the first end 232. The second section 229b extends from that point to the first end 232.

In one embodiment, the first and second sections 229a,229b are divided by a wall 231. The wall 231 preferably spans or closes the interior of the wall 222, creating the two compartments or areas. Other means may be utilized to divide the interior into one or more sections or compartments

In this embodiment, the cartridge 234 is preferably shaped so that it extends into and occupies only the second interior section 229b. As illustrated, in order for the cartridge 234 to contain a similar quantity of ink or other material, this may require that the diameter of the cartridge 234 be increased.

In this embodiment, ornamental elements 240 occupy all or a portion of the first interior section 229a.

This embodiment implement 230 has similar advantages to those described above, including the fact that the cartridge 234 may be replaced without affecting the ornamental elements 240 located in the first interior section 229a.

The interior 228 may be divided into a plurality of areas. The various areas may be filled with different elements 240, such as elements of differing colors to create a desired pattern.

The configurations of the writing implement described are as a “ball-point” ink type apparatus. It will be appreciated, however, that the writing implement may be configured to dispense other materials, such as high-light or fluorescent material, lead/graphite and a variety of other materials. In general, it is simply desired that the implement be capable of dispersing or dispensing a writing or drawing material from the tip thereof.

Depending on the material which is to be dispensed, the configuration of the implement may vary. For example, in the case of a mechanical type pencil, the implement may include a lead chamber. This chamber may be defined inside of the housing of the implement. In such event, the ornamental elements once again serve to obscure this housing or internal mechanisms such as a lead feed mechanism.

In the case of a marker, the ink may be contained in a felt element. This element may extend into the interior space defined by the housing. Once again, the ornamental elements are preferably located so that they obscure the felt retaining ink.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A writing implement comprising an elongate, generally cylindrical housing having a first end and a second end, said housing defining an interior area, said housing comprising a substantially translucent material, said second end of said housing and said interior closed, said implement including a tip at said first end of said housing, said writing implement including at least one writing material configured to be dispensed from said tip, said implement including a plurality of ornamental elements substantially filling said interior area between said first end and second end of said housing.

2. The writing implement in accordance with claim 1 wherein said ornamental element comprise balls having a diameter in the range of about 0.03125-0.125 inches.

3. The writing implement in accordance with claim 1 wherein said writing material comprises ink contained in a cartridge, said cartridge including a dispenser extending from said tip of said writing implement and including a well, said well comprising a generally cylindrical housing extending into said interior area of said housing.

4. The writing implement in accordance with claim 3 wherein said ornamental elements are located in an annular space between said housing and said well of said cartridge.

5. The writing implement in accordance with claim 1 wherein said housing comprises an inner wall and an outer wall, a first interior area defined between said inner and outer walls and a second interior area defined inside of said inner wall, said ornamental elements located in said first interior area.

6. The writing implement in accordance with claim 1 wherein said interior area includes a first interior section located between said second end of said housing and a point distal of said first end, and a second interior section located between said point and said first end, said ornamental elements located in said first interior section.

7. The writing implement in accordance with claim 6 wherein said first and second interior sections are divided by a wall located in said interior space defined by said housing.

8. The writing implement in accordance with claim 1 wherein said ornamental elements having a maximum dimension in the range of about 0.03125-0.125 inches.

9. The writing implement in accordance with claim 1 wherein said ornamental elements have a size in relation to a distance across said interior space that at least three ornamented elements fit within said distance.
